(19) United States
(12) Patent Application Publication
(10) Pub. No.: US 2013/0035870 A1
(43) Pub. Date: Feb. 7, 2013

(54) APPARATUS AND METHOD FOR MEASURING AIR QUALITY

(71) Applicants: Lei Feng, Eindhoven (NL); Jun She, Eindhoven (NL)

(72) Inventors: Lei Feng, Eindhoven (NL); Jun She, Eindhoven (NL)

(73) Assignee: KONINKLIJKE PHILIPS ELECTRONICS N.V., EINDHOVEN (NL)

(21) Appl. No.: 13/641,273

(22) PCT Filed: Apr. 13, 2011
(86) PCT No.: PCT/IB11/51590

§ 371 Date: Oct. 15, 2012

(30) Foreign Application Priority Data
Apr. 29, 2010 (CN) 201010163319.8

(51) Int. Cl. G01N 1/22; G06F 19/00

(52) U.S. Cl. 702/24

(57) ABSTRACT

To improve the measurement accuracy of an air analyzer, a method of introducing position information to group and average a set of position-dependent air quality samples is proposed. The method comprises the steps of sampling the air at a first sampling rate to obtain a plurality of air quality samples by using a first sensor; sampling the positions of an apparatus at a second sampling rate to obtain a plurality of position samples; analyzing the plurality of position samples to obtain a plurality of spatial relationship information; grouping the plurality of air quality samples into a second plurality of air quality sample sets; and for each air quality sample set, calculating a representative value as the air quality value of a corresponding sampling duration. By using this method, non-position-relevant air quality samples can be excluded from the calculation of the air quality of a specific position or area.

### FIELD OF THE INVENTION

The present invention relates to apparatus for measuring air quality, particularly mobile air analyzers and air measurers.

### BACKGROUND OF THE INVENTION

Measuring air quality is an important way of gaining knowledge about the environment, for example aerial contaminants, gas concentration, dust emission, gaseous emission, etc. The accuracy of measuring air quality, for example identifying contained pollutants and measuring their concentrations, is very important for the further processing, like air purification, air disinfection, locating the source of emission, etc.

There is also a need to measure the air by means of a portable air analyzer moving, especially, in some high-security places. US patent application US20090139299A1 discloses a method of using special and temporal information to measure gas concentration. In US20090139299A1, a sensor periodically measures the gas concentration, and a tracking system tracks the position of the sensor and maps the tracked positions to a defined area. When the sensor senses a gas concentration above a predefined threshold, the corresponding position is used to locate the source of the emission. In US20090139299A1, the temporal information, i.e., the tracked positions, is used to locate the source of the emission, not to improve the accuracy of the measurement.

Thus there is a need to improve the measurement accuracy of a mobile air measurer.

### SUMMARY OF THE INVENTION

The inventors of the present invention found that, due to the movement of the air measurer, a plurality of consecutively measured air quality samples may have a loose correlation between them, which means that two air quality samples measured within a significantly short period may correspond to two geographic positions far away from each other. This impact becomes more severe especially when the air measurer moves at a relatively high velocity. For air sensors which average a number of air quality samples measured within a predefined period as a representative air quality value of the predefined period or of a position corresponding to the predefined period, the measurement accuracy is negatively impacted, since the plurality of air quality samples may be collected from two or more positions far away from each other. Thus, the calculated representative air quality value is not suitable to represent the air quality of the corresponding position.

It is an object of the present invention to utilize the temporal information and spatial information to improve the measurement accuracy of an air measurer.

According to an embodiment of the present invention, there is provided an apparatus for measuring air quality comprising a first sensor, a second sensor and a processor. The first sensor is configured to sample air at a first sampling rate to generate a plurality of air quality samples; the second sensor is configured to sample the positions of the movement of the apparatus at a second sampling rate to generate a plurality of position samples; and the processor is configured to analyze the plurality of position samples to obtain a plurality of spatial relationship information, each spatial relationship information representing the relative spatial relationship of two corresponding position samples. The processor is further configured to group the plurality of air quality samples into a plurality of air quality sample sets, on the basis of the plurality of spatial relationship information. And the processor is further configured to calculate, on the basis of each air quality sample set, a representative value for the air quality sample set, the representative value representing the air quality value of a corresponding sampling duration.

The basic idea of the embodiment is to use the spatial information to group the plurality of measured air quality samples into different sets, the air quality samples in one common set exhibit mutual relevance in spatial domain. Thus, the air quality samples having correlation in spatial domain can be averaged to generate a representative air quality value to represent the air quality of a corresponding position. Therefore, the measurement accuracy can be improved.

Optionally, the first sampling rate and the second sampling rate can be the same, or different. When the two sampling rates are the same, the sampling instants for sampling air quality and sampling positions can be completely superposed, or different without the need of overlap. The requirement on the two sampling rates is that the air quality sample and the position sample have temporal correlation, thus it is possible to establish the mapping between one air quality sample and one position sample, both sampled within a meaningful period, even if the corresponding sample instants are not completely superposed in time dimension.

Optionally, the processor is further configured to calculate the representative air quality value when the number of air quality samples of an individual air quality sample set is larger than a predefined threshold. This is meaningful for those air sensors that need quite a significant amount of air quality samples to generate a representative air quality value.

Optionally, the processor is further configured to group the plurality of air quality samples into a plurality of air quality sample sets. Within each air quality sample set, any two air quality samples have a sampling instant difference smaller than a predefined threshold. Therefore, the air quality samples in one common set have relevance not only in spatial domain, but also in temporal domain.

Optionally, the processor can decide to turn on or turn off the first sensor, based on the velocity of the apparatus, the latter can be calculated on the basis of the plurality of position samples.

According to an embodiment of the present invention, a corresponding method of measuring air quality is provided.

These and other aspects of the invention will be apparent from and elucidated with reference to the embodiments described hereinafter.

### BRIEF DESCRIPTION OF THE DRAWINGS

The above and other objects and features of the present invention will become more apparent from the following detailed description considered in connection with the accompanying drawings, in which:

FIG. 1 illustrates an exemplary apparatus for measuring air quality, according to an embodiment of the present invention;

FIG. 2 illustrates two exemplary tables representing the temporal correlation between the sampled air quality sample and the sampled position sample;

FIG. 3 illustrates the flowchart of a method of measuring air quality, according to an embodiment of the present invention;

FIG. 4 illustrates the flowchart of a method of grouping the plurality of air quality samples and calculating a representative air quality value, according to an embodiment of the present invention; and

FIG. 5 illustrates two exemplary movement routes and corresponding sampled position samples, according to an embodiment of the present invention.

The same reference numerals are used to denote similar parts throughout the Figures.

### DETAILED DESCRIPTION OF THE EMBODIMENTS

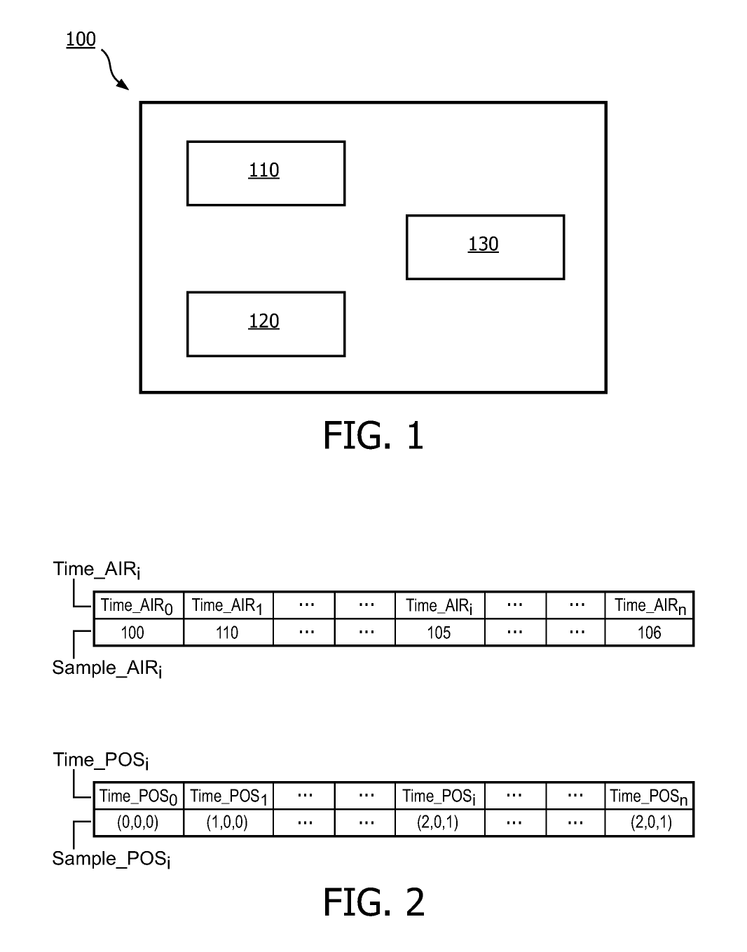

FIG. 1 illustrates a schematic block diagram of an apparatus 100 capable of measuring air quality.

The apparatus 100 can be an air analyzer, an air measurer, an air purifier, an air disinfector, and any other type of product having the function of measuring air quality. The apparatus 100 comprises a first sensor 110, a second sensor 120 and a processor 130. The first sensor 110 is used to measure air quality by sampling the air at a first sampling rate, thereby generating a plurality of air quality samples. The second sensor 120 is used to track the apparatus 100 by sampling the position of the movement of the apparatus 100 at a second sampling rate, thereby generating a plurality of position samples. And the processor 130 can analyze the plurality of position samples to obtain a plurality of spatial relationship information, each spatial relationship information representing the relative spatial relationship of two corresponding position samples. On the basis of the plurality of spatial relationship information, the processor 130 can group the plurality of air quality samples into a plurality of air quality sample sets; and on the basis of each air quality sample set, the processor 130 can calculate a representative value for the air quality sample set. The calculated representative value can be represented as the air quality value of a corresponding sampling duration. The spatial relationship information can be a 2-dimensional distance, 3-dimensional distance, altitude difference, change in angle of movement, angle of swerve, or any other type of (?) metric describing spatial information.

In the above-described embodiment, there is no need for the second sensor 120 to track the movement of the first sensor 110; it is the movement of the apparatus 100 that is measured instead. In many cases, tracking an apparatus is much easier than tracking an air sensor, in the latter case the second sensor 120 needs a higher sensitivity to the movement of the first sensor 110. However, in the above-described embodiment, the movement of the apparatus 110 represents the movement of the first sensor 110. This is valid especially when the spatial relationship between the first sensor 110 and the apparatus 100, and the spatial relationship between the second sensor 120 and the apparatus 100 are substantially fixed. Of course, the embodiment in which the second sensor is used to directly measure the movement of the first sensor is also within the scope of the invention.

In the embodiments of the present invention, the first sampling and the second sampling are not required to be strictly synchronized or superposed. Both samplings can have the same sampling rate, and may be performed at substantially the same sampling instants or in a synchronized manner. It is also possible that the two sampling rates are different. The two samplings can be performed at different sampling instants, or even the number of samplings within a same period may be different. The minimum requirement imposed on the two samplings is the need for temporal correlation. In other words, it is sufficient if (a portion of) the plurality of position samples can be mapped to (a portion of) the plurality of air quality samples through their temporal correlation in time domain. This is valid especially when the differences between the sampling instants respectively for sampling air quality and sampling the position are within the amount of tolerance permitted by the apparatus or permitted for the corresponding applications.

FIG. 2 illustrates an exemplary measurement process. The processor 130 maintains two tables, one for recording the sampling instants Time_AIR_{I} of measuring the air quality and the measured plurality of air quality samples Sample_AIR_{I}, and the other for recording the sampling instants Time_POS_{I} of measuring the position of the apparatus 100 and the measured plurality of position samples Sample_POS_{I}.

Time_AIR_{I} can be the same as Time_POS_{I} which means that the air quality and the position of apparatus 100 are measured in a synchronized manner However, they can also be different. For example, the sampling instants can be in the sequence of [. . . Time₁₃ AIRᵢ, Time_POSᵢ, Time_AIRᵢ₊₁, Time_POSᵢ₊₁ . . . ], or in the sequence of [. . . Time_AIRᵢ, Time_AIRᵢ₊₁, Time_POSᵢ, Time_AIRᵢ₊₂, Time_AIRᵢ₊₃, Time_POSᵢ₊₁ . . . ] in time dimension.

The position sample Sample_POSᵢ can be expressed in the form of an absolute 2D or 3D geographic coordinate, or in the form of a relative 2D or 3D parameter corresponding to a reference point. In the exemplary table 2, the position sample_POSᵢ is represented as (xᵢ, yᵢ, zᵢ) while the origin Sample_POS₀ is represented as (0, 0, 0). The spatial relationship information, for example the distance, between two arbitrary positions can be calculated based on their 3-dimension metric. In the present invention, the second sensor 120 can be any kind of sensor applicable for measuring the absolute position or relative position of an object. For example, it can be a GPS sensor, a motion sensor, a two-axis accelerator sensor, a three-axis accelerator sensor, an IR sensor, etc. The person skilled in the art should understand that the second sensor 120 can be a sensor capable of independently measuring the movement or position of the apparatus; also it can be part of a tracking/positioning system. For example, the second sensor 120 can be a receiver of a wireless network or infrared network having a plurality of known-position transmitters. The second sensor 120 can receive signals from the transmitters and calculate the distance from the transmitters to obtain its own position. The Sample_POSᵢ can be represented in the form of any applicable metric, depending on the used second sensor.

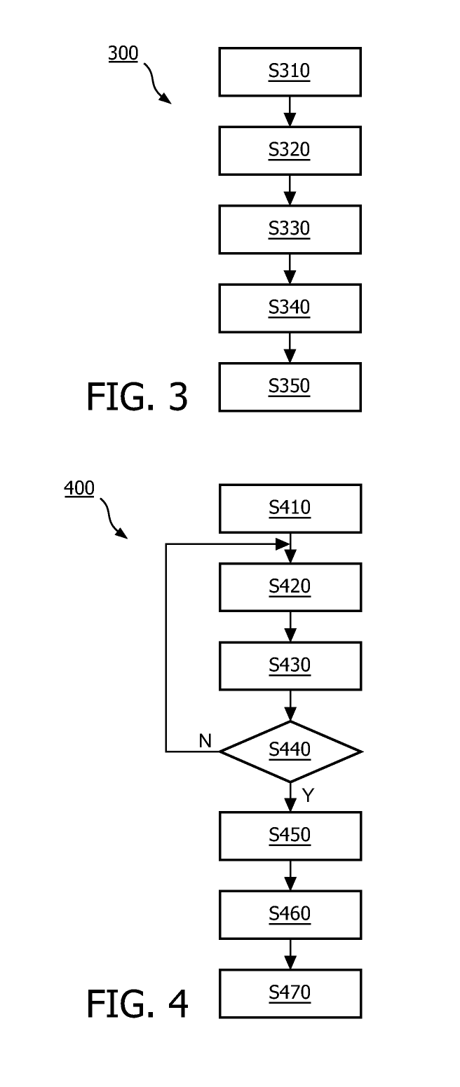

FIG. 3 illustrates the flowchart of an exemplary method of measuring air quality. The method 300 firstly comprises the step S310 of sampling the air at the first sampling rate to obtain a plurality of air quality samples. This can be performed by the first sensor 110. Secondly, step S320 is performed to sample the position of the apparatus at the second sampling rate to obtain a plurality of position samples. This can be done by the second sensor 120. The method 300 further comprises the step S330 of analyzing the plurality of position samples to obtain a plurality of spatial relationship information, each spatial relationship information representing the relative spatial relationship of two corresponding position samples. Step S340 is performed, on the basis of the plurality of spatial relationship information, to group the plurality of air quality samples into a second plurality of air quality sample sets. In Step S350, for each air quality sample set, a representative value is calculated as the air quality value of a corresponding sampling duration.

Some air sensors measure air quality by first sampling a number of air quality samples within a limited duration, and then averaging the number of air quality samples, resulting in an individual representative value as the measured air quality sample sampled within said limited duration or a at corresponding position. When the air sensor is moving, it is possible that the first portion of the air quality sample is measured at a position far from a position where the second portion of the air quality sample is measured. This will make the averaging process meaningless and the final representative value cannot represent the air quality of any position. The present invention introduces the geographic correlation among a plurality of positions to mitigate or even eliminate the improper averaging of a plurality of air quality samples. Therefore the measurement accuracy is improved.

In an exemplary embodiment, a method of grouping the plurality of measured air quality samples by calculating a representative air quality value is illustrated. In step S410, a target position sample is selected, for example from the plurality of measured position samples. Then, in step S420, a circle is drawn, the target position being the center thereof and a first predefined threshold being the diameter. In step S430, the measured position sample, or a predefined number of measured position samples, falling into the circle, are grouped as a second plurality of position samples. In step S450, one or more air quality samples having temporal correlation with one position sample of the second plurality of position samples is found. All the found air quality samples form an air quality sample set. And a representative value is calculated in step S470 as the air quality value of a corresponding sampling duration or a corresponding geographic area. These steps can be performed by the processor 130.

Some air sensors need a significant number of measured air quality samples to perform the averaging process; otherwise the precision is insufficient. For this purpose, the method illustrated in FIG. 4 can comprise an optional step S440 of comparing the number of position samples in the second plurality of position samples with a second predefined threshold. Only when the number of position samples is larger than the second predefined threshold, the following steps S450 and S470 will be performed. Otherwise, the circle of step S420 can be reselected by using a larger diameter so as to include more position samples into the second plurality of position samples, or the selected second plurality of position samples is omitted.

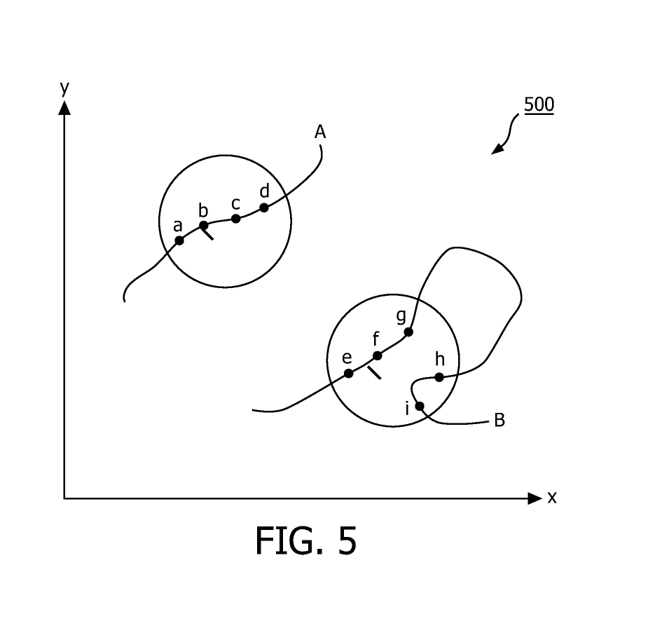

The second plurality of position samples may comprise a number of consecutively measured position samples, like points a, b, c, d in curve A of FIG. 5, or a number of position samples measured at intervals, like points e, f, g, h, i in curve B of FIG. 5. The latter scenario is meaningful when the movement of the apparatus is zigzag and the air quality of the target area changes slowly.

Sometimes, the air condition of the environment changes relatively rapidly, or some sensors can only average a number of consecutive air quality samples. For this purpose, the method illustrated in FIG. 4 can further comprise an optional step S460 to make sure that the difference between sampling instants of one selected air quality sample and a target air quality sample corresponding to the target position sample is smaller than a third predefined threshold. Therefore, air quality samples measured far from the target air quality sample in time dimension are excluded. For example, in FIG. 5, points e, f and g can be selected in the average process while points h and i are excluded since they are sampled in a period far from the period of sampling points e, f, and g, although the spatial distances between (h, i) and (e, f, g) are within the second predefined threshold.

Optionally, the processor 130 can measure the velocity of the movement of the apparatus to decide whether it is meaningful to sample the air. If the velocity of the apparatus is larger than a fourth predefined threshold, the processor 130 can disable the first sensor 110 and/or the second sensor 120.

In another embodiment of the present invention, a set of computer-executable instructions is given, which can perform part or all of the steps illustrated in FIGS. 3 and 4. While discussed in the context of computer program code, it should be understood that the modules may be implemented in hardware circuitry, computer program code, or any combination of hardware circuitry and computer program code.

It should be further noted that the aforesaid embodiments are illustrative and not restrictive. The present invention is not limited by the aforesaid embodiments.

It will be apparent to those skilled in the art that various modifications and variations can be made in the present invention without departing from the spirit or scope of the invention. The scope of protection of the invention is not restricted by the reference numerals in the claims; the word “comprising” does not exclude parts other than those mentioned in the claims; the word “a(n)” preceding an element does not exclude a plurality of those elements; means forming part of the invention may be implemented in the form of dedicated hardware or in the form of a programmed processor; the use of the words first, second and third, et cetera, does not indicate any ordering, these words are to be interpreted as names.

1. An apparatus for measuring air quality, comprising:
a) a first sensor, configured to sample the air at a first sampling rate to generate a plurality of air quality samples;
b) a second sensor, configured to sample the position of the movement of the apparatus at a second sampling rate to generate a plurality of position samples;
c) a processor, configured to analyze the plurality of position samples to obtain a plurality of spatial relationship information, each spatial relationship information representing the relative spatial relationship of two corresponding position samples; wherein, the processor is further configured to group the plurality of air quality samples into a plurality of air quality sample sets, on the basis of the plurality of spatial relationship information, and the processor is further configured to calculate, on the basis of each air quality sample set, a representative value for the air quality sample set, the representative value representing the air quality value of a corresponding sampling duration.

2. The apparatus of claim 1, wherein the first and the second sampling rates are temporally correlated.

3. The apparatus of claim 1, wherein the processor is further configured to select a target position sample and a second plurality of position samples, each selected position sample of the second plurality of position samples representing a position within an area, with a position represented by the target position sample being the center and a first predefined threshold being the diameter, and the processor is further configured to select a second plurality of air quality samples, each selected air quality sample corresponding to a selected position sample, and the processor is further configured to calculate the representative value as the air quality value of the selected target position sample.

4. The apparatus of claim 3, wherein the processor is further configured to calculate the representative value when the number of the second plurality of position samples is larger than a second predefined threshold.

5. The apparatus of claim 3, wherein the difference between the sampling instants of each selected air quality sample and the target air quality sample is smaller than a third predefined threshold.

6. The apparatus of claim 3, wherein the first predefined threshold represents any one of a geometric distance, an altitude difference, and an angle of swerve.

7. The apparatus of claim 1, wherein the second sensor is any one of a GPS receiver, an IR sensor, a movement detection sensor, a two-axis accelerator sensor and a three-axis accelerator sensor.

8. The apparatus of claim 7, wherein the second sensor is any one of a two-axis accelerator sensor and a three-axis accelerator sensor, each generated position sample is a geometric data, and each spatial relationship information is determined by two corresponding geometric data.

9. The apparatus of claim 1, wherein the processor is further configured to calculate a velocity of the apparatus on the basis of the plurality of position samples and compare the velocity with a fourth predefined threshold so as to determine turn on or turn off the first sensor.

10. A method of measuring air quality, comprising the steps of:
a) sampling the air at a first sampling rate to obtain a plurality of air quality samples by using a first sensor;
b) sampling the position of an apparatus at a second sampling rate to obtain a plurality of position samples;
c) analyzing the plurality of position samples to obtain a plurality of spatial relationship information, each spatial relationship information representing the relative spatial relationship of two corresponding position samples;
d) on the basis of the plurality of spatial relationship information, grouping the plurality of air quality samples into a second plurality of air quality sample sets; and
e) calculating a representative value for each air quality sample set as the air quality value of a corresponding sampling duration.

11. The method of claim 10, wherein step c) further comprises a step of:
I). Selecting a target position sample and a second plurality of position samples, each selected position sample of the second plurality of position samples representing a position within an area in which a position represented by the target position sample is the center and a first predefined threshold is the diameter; and
In step d), each selected air quality sample of the second plurality of air quality sample sets is temporally correlated with a corresponding position sample of the second plurality of position samples.

12. The method of claim 11, wherein the step I) further comprises a step of:
i). comparing the number of the second plurality of position samples with a second predefined threshold.

13. The method of claim 11, wherein the difference between the sampling instants of one selected air quality sample and the target air quality sample is smaller than a third predefined threshold.

14. A set of computer-executable instructions, capable of executing the method of claim 10.
